(19) United States
(12) Patent Application Publication
(10) Pub. No.: US 2010/0014045 A1
(43) Pub. Date: Jan. 21, 2010

(54) Interchangeable Personalized Attachment Device

(75) Inventor: Misty Reeves MacCallum, Rocky Point, NC (US)

Correspondence Address: WARD AND SMITH, P.A., 1001 COLLEGE COURT, P.O. BOX 867, NEW BERN, NC, 28563-0867, US

(73) Assignee: FLIPABLES, LLC, Rocky Point, NC (US)

(21) Appl. No.: 12/503,943

(22) Filed: Jul. 16, 2009

Related U.S. Application Data
(60) Provisional application No. 61/081,920, filed on Jul. 18, 2008.

(51) Int. Cl. G02C 11/02; A43B 23/00

(52) U.S. Cl. 351/52; 36/136

(57) ABSTRACT

The present invention relates generally to interchangeable personalized attachment devices that can be affixed to accessories worn by a person, and more particularly to decorative devices that attach to shoes, sunglasses, and other accessories. The device includes a material having two ends and is configured to wrap and fasten around the accessory at the two ends by a removable fastener.

### CROSS-REFERENCE TO RELATED APPLICATIONS

This application claims priority and is related to U.S. Provisional Patent Application Ser. No. 61/081,920, filed Jul. 18, 2008; the entire disclosure of which is incorporated by reference in its entirety.

### BACKGROUND OF THE INVENTION

1. Technical Field

The invention disclosed herein relates generally to interchangeable personalized attachment devices that can be affixed to accessories worn by a person, and more particularly to removable and interchangeable decorative devices that attach to shoes, sunglasses, and other accessories.

2. Background Art

Personalization of accessories allows people to make a fashion statement and show their uniqueness and individuality. Previous art has attempted to address the need of people to personalize parts of their fashion accessories.

For example, U.S. Pat. No. 5,673,499 to Attilieni teaches a removable portion of a shoe tongue that includes a light source. This invention requires a shoe tongue and would not be appropriate for shoes that do not have a tongue. U.S. Pat. No. 5,496,612 to Ransbottom discloses a strap for the front of a shoe that can hold decorative items. However, this invention requires the strap to be secured around the ball of the foot which may be uncomfortable. U.S. Pat. No. 7,328,528 to Caminiti discloses a decoration for footwear that requires a hook-shaped tool to attach elastic bands to the decoration and to the footwear. U.S. Patent Application Publication No. 20090007459 to Barnett teaches a footwear accessory holder which comprises a mount attachable to the footwear and a display item retainer. This invention requires a flat attachment piece which would not be compatible with some styles of shoes, such as shoes with straps.

In addition to the drawbacks of the prior art discussed above, the prior art cited above is specifically made for footwear and cannot be easily attached to other accessories. As such, there remains the need for a personalized attachment device that can be easily and quickly attached to an accessory and moved from one accessory to another quickly.

### BRIEF SUMMARY OF THE INVENTION

According to one embodiment of the present invention, an interchangeable personalized attachment device is provided wherein the apparatus comprises an attachment to an accessory worn on a person, the device comprising a material having two ends and configured to wrap and fasten around the accessory at the two ends. In a preferred embodiment, the apparatus is comprised of fabric that is embroidered with initials, pictures, logos, names, and the like.

It is therefore an object to provide attachment devices that are easily and quickly interchangeable between the same type of accessory (for example, from one kind of footwear to another kind of footwear) as well as between different types of accessories (for example, from a piece of footwear to a purse handle). The attachment devices may be termed “Flipables™” in some embodiments where they are attached to flip flop sandals or shoes with straps. In other embodiments, the attachment devices may be termed “Initialeyes™” when they are affixed to sunglasses.

In another exemplary embodiment, the attachment devices may be configured to conform to the accessory more closely such that when the attachment device is in place on the desired accessory the device remains securely in place. The attachment device remains securely in place not only due to the attachment portion but also because it is in better conformance with the structural geometry of the accessory to which it is attached. Thus, when affixed properly the attachment device remains securely affixed at the desired location to which it was initially placed upon the accessory.

An object of the present invention having been stated hereinabove, and which is addressed in whole or in part by the present invention, other objects will become evident as the description proceeds when taken in connection with the accompanying drawings as best described hereinbelow.

### BRIEF DESCRIPTION OF THE DRAWINGS

FIG. 1 is a plan view of a monogrammed attachment device of the present invention;

FIG. 2 is a perspective view of a flip flop sandal with a monogrammed attachment device being applied on one of the straps;

FIG. 3 is a perspective view of a flip flop sandal with a monogrammed attachment device fully applied to one of the straps; and

FIG. 4 is a perspective view of sunglasses with a monogrammed attachment device being applied on one of the side arms.

### DETAILED DESCRIPTION OF THE INVENTION

The present invention provides an interchangeable personalized attachment device wherein the device comprises an attachment to an accessory worn on a person. The attachment device comprises a material having two ends and is configured to wrap and fasten around a part of the accessory. It is an object of the invention to attach a type of interchangeable decorative device to an accessory for the purpose of personalizing the accessory.

By interchangeable, it is meant that the attachment device can be transferred from one accessory to another. The two accessories may be the same type, such as two pairs of sunglasses. The two accessories may also be different types, such as a flip flop sandal and a belt. In addition, the invention may be configured to adapt to the geometry of the accessory to which it is fastened. In transferring the attachment device from an accessory such as a sandal to an accessory such as a side arm of a pair of sunglasses with a tapered geometry, the attachment portion of the attachment device may be configured to allow the attachment device to conform to the geometry of the accessory by controlling the fastening point of the attachment device. In a non-limiting example, the fastening point of the attachment device may be overlapped in a straight fashion to form a configuration that mimics the geometry of the strap of a sandal, then, when transferred to the tapered sunglasses accessory, the fastening point of the attachment device may be overlapped in a tapered fashion to provide conformance with the geometry of the tapered belt.

In an alternative non-limiting example, the attachment device itself may be constructed with a tapered geometry to provide attachment to accessories requiring more extreme tapering or shape adjustment. The invention is not limited by the examples discussed herein as the attachment device can be attached to and transferred between many different accessories. The device may also be reversible when attached to one or more accessories.

The attachment device can be personalized in some way to allow the accessory to be unique to the individual. For example, the attachment device can be embroidered with the initials of the wearer. As other non-limiting examples, the device can be embroidered with pictures, logos, names, and the like. In another embodiment, the device is not embroidered.

The accessory for the attachment can be any object that is worn by a person. In one embodiment, it is a shoe with straps, such as a flip flop sandal. In another embodiment, it is a pair of glasses, such as a pair of sunglasses. Other embodiments may include attachment devices for belts, jewelry, small carrying cases, purses, bracelets, keychains, clothing (such as spaghetti straps on a dress), or any other object which a person may use for adornment or practical wear in enhancing personal style.

The material comprising the accessory can be any kind of material that can be folded over to wrap around the accessory and that can typically be embroidered. For example, the material may be different types of fabric, such as cotton, nylon, polyester, and the like. The material may be any color or pattern, which by itself may bring personalization to the wearer. The material may be any shape, such as rectangular, square, triangular, circular, octagonal, and the like. The shaped material may also be constructed in a number of different shapes and widths to accommodate any desire for transferring the attachment device to a variety of personal accessories. Preferably, the material is in the form of a band that is rectangular. The material may also have any number of apertures for decoration and/or to attach other decorative pieces to the device.

The attachment device is typically secured to the accessory in a non-permanent or removable way. Therefore, many different means of attachment are envisioned, such as hook and loop material (such as that sold under the trademark VELCRO®), string, snap fasteners, magnets, buttons, clasps, or any other fastener for removably securing one surface to another surface. The non-permanent fastening means may be integrated into the attachment device such that the shape of the attachment device may conform to variations in the shape of accessories. In a non-limiting example, a hook and loop attachment means, such as VELCRO®, may be affixed to the edges of the attachment device in a wide enough band such that a tapered overlap may be supported without impacting the security of the attachment to the accessory. In another non-limiting example, the fastening means may be configured such that a tapered geometry is the preferred geometry of the attachment device by locating one end of the attachment means closer to the edge of the attachment device than the second end of the attachment means.

By providing for variations in the geometry of the attachment point for accessories, the attachment device may conform to the geometry of the accessory. This conformance provides for better security of both attachment and placement of the attachment device on the desired accessory.

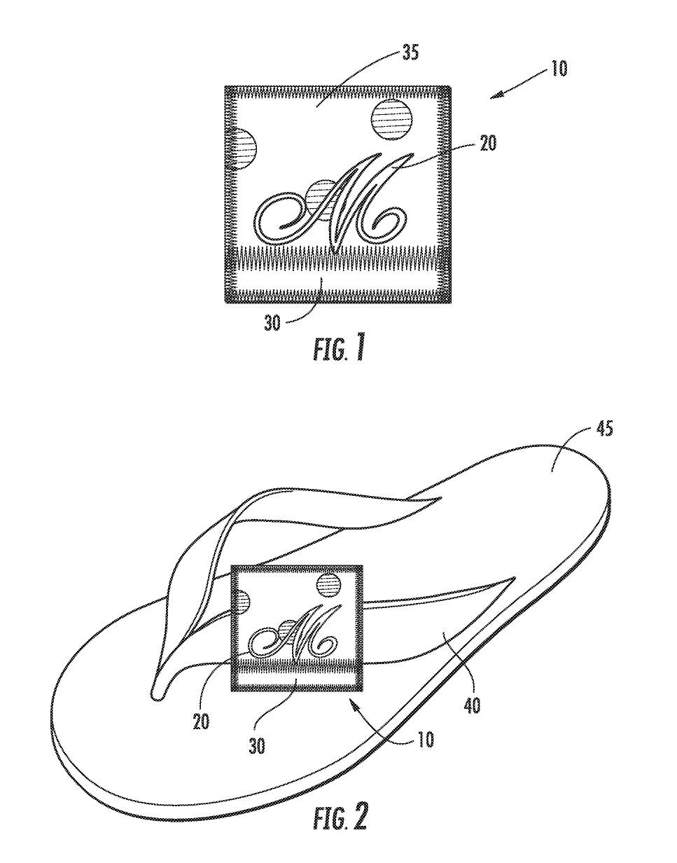

Referring now to FIGS. 1-3, an embodiment of the present invention is shown which is termed “Flipables™” and in which the device 10 is wrapped around a strap 40 of a flip flop 45. FIG. 1 depicts a non-limiting example of a monogrammed embodiment of the device 10 comprising VELCRO® on the upper surface at one end 30 and VELCRO® on the bottom surface at the other end 35 (VELCRO® not shown). The monogram 20 is embroidered on the device 10. As may be seen in FIG. 1, the attachment device 10 is generally square in configuration although any shaped configuration is contemplated. The VELCRO® fastening means, as is typical of hook and loop fastening means, consists of two portions, the hook section and the loop section such that when overlapped the hook and loop potions of the fastening means come in contact. FIG. 1 shows one half of the VELCRO® fastening means integrated with the upper surface at one end 30 of the attachment device 10, and aligned in a straight fashion in conformance with the straight lower edge of the attachment device 10. The second portion of the VELCRO® fastening means is integrated with the underside at the second end 35 of the attachment device 10 (VELCRO® not shown) and also aligned along the straight upper edge of the attachment device 10 such that when the attachment device 10 is wrapped around a suitable portion of the geometry of an accessory, the first end 30 and second end 35 of the fastening device, along with the hook portion and the loop portion of the VELCRO®, come into contact and form a secure attachment.

Although FIG. 1 depicts a monogrammed embodiment of the attachment device 10, the attachment device 10 may be embroidered with any word, symbol, device, bead, or other item that it is possible to secure to a cloth material (or may be unembroidered). The attachment device 10 may also be unadorned and provide a simple conforming band for attachment to an accessory.

FIG. 2 shows the device 10 prior to being wrapped around the strap 40 of the flip flop 45. In this non-limiting example, the device 10 is being wrapped in such a fashion as to present the monogrammed portion 20 on the upper portion of the strap 40 of the flip flop 45. In this example, the geometry of the strap of the flip flop is a straight piece of material with little or no taper from one end to the other. The device 10 therefore may be wrapped around the strap 40 of the flip flop 45 in such a fashion as to cause the first portion (hook or loop) to align with the second portion (hook or loop) of the fastening means.

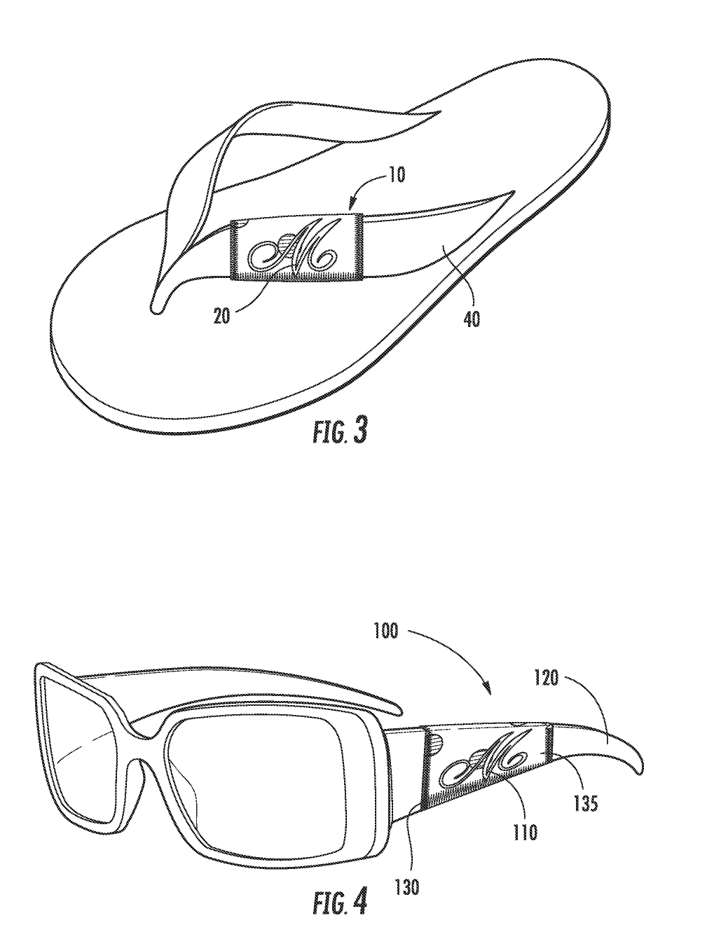

FIG. 3 depicts the device 10 after being wrapped around the strap 40 and after the two ends 30, 35 of the device 10 are joined by the VELCRO® fastener. When the attachment is complete, the attachment device 10 is securely fastened to the desired portion of the flip flop 45 with the monogrammed surface 20 upright and the two portions of the fastening means aligned and non-visible.

Where the geometry of the portion of the flip flop 45, to which the attachment device 10 is to be secured, is configured with non-linear portions, the fastening means is of sufficient width and flexibility to allow attachment and conformance to that portion of the flip flop 45, or other accessory.

FIG. 4 depicts an embodiment of the present invention termed “Initialeyes™” in which the device 100 is wrapped around the side arm 120 of a pair of sunglasses. In this non-limiting embodiment, it may be preferable for the device 100 to be wider on one side 130 compared to the other side 135 to follow the changing width of the side arm 120 of the sunglasses. The monogram 110 is embroidered onto the device 100 such that the monogram is visible on the top portion of the attachment device 100 when the device 100 is attached to the accessory 120.

Other configurations of the device 100 are possible, with regard to either the shape of the attachment device 100, or the width and placement of the fastening means. In an alternate, non-limiting embodiment, the fastening means may be marginally wider when emplaced on the attachment device 100. This additional width of the fastening means may provide for geometries other than a straight geometry. By providing additional fastening means area, geometries that would be too difficult to accommodate with a narrow band of hook and loop or other fastening means may be accommodated. The fastening means will be broad enough to allow the attachment device 100 to stretch over the non-straight geometry yet still have enough of the fastening area of the fastening means in contact to provide for secure attachment.

In another configuration, the attachment device 100 may be manufactured in a different shape or size such that the fastening means is affixed in a non-straight line manner. A number of differing accessory geometries may be addressed by a combination of the location and arrangement of the fastening means upon the attachment device 100.

The foregoing detailed description of embodiments refers to the accompanying drawings, which illustrate specific embodiments of the invention. Other embodiments having different structures and operations do not depart from the scope of the present invention.

The term “the invention” is used with reference to certain specific examples of the many alternative aspects or embodiments of the applicant's invention set forth in this specification, and neither its use nor its absence is intended to limit the scope of the applicant's invention or the scope of the claims.

This specification is divided into sections for the convenience of the reader only. Headings should not be construed as limiting of the scope of the invention.

It will be understood that various details of the present invention may be changed without departing from the scope of the present invention. Furthermore, the foregoing description is for the purpose of illustration only, and not for the purpose of limitation, as the present invention is defined by the claims as set forth hereinafter.

What is claimed is:

1. An interchangeable personalized device for attachment to an accessory worn on a person, the device comprising a material having two ends and configured to wrap and fasten around the accessory at the two ends by a removable fastener.

2. The device of claim 1, wherein the device is comprised of fabric selected from the group consisting of cotton, nylon, and polyester.

3. The device of claim 2, wherein the device comprises a piece of material in the shape of a regular polygon.

4. The device of claim 2, wherein the device comprises a piece of material with one end of the material wider than a second end of the material wherein the device forms a tapered structure when wrapped around an accessory.

5. The device of claim 1, wherein the device is embroidered by an embroidery.

6. The device of claim 5, wherein the embroidery is a monogram.

7. The device of claim 1, wherein the fastener is selected from the group consisting of hook and loop material, string, snap fasteners, magnets, buttons, and clasps.

8. The device of claim 7, wherein the fastener comprises a hook and loop type fastener.

9. The device of claim 1, wherein the accessory is a flip flop sandal and the device is adapted for wrapping around a strap of the flip flop sandal.

10. The device of claim 1, wherein the accessory is a pair of sunglasses and the device is adapted for wrapping around a side arm of the sunglasses.

11. The device of claim 1, wherein the fastener is affixed such that a first end is located in close proximity to an edge of the device and a second end is located a different distance from said edge of the device.

12. The device of claim 1, wherein the material is reversible.
